(19) United States
(12) Patent Application Publication
(10) Pub. No.: US 2019/0312478 A1
(43) Pub. Date: Oct. 10, 2019

(54) THREE-PHASE MOTOR STATOR

(71) Applicant: SUNONWEALTH ELECTRIC MACHINE INDUSTRY CO., LTD., KAOHSIUNG CITY (TW)

(72) Inventors: ALEX HORNG, KAOHSIUNG (TW); TSO-KUO YIN, KAOHSIUNG (TW); KUN-TA YANG, KAOHSIUNG (TW)

(21) Appl. No.: 16/151,711

(22) Filed: Oct. 4, 2018

(30) Foreign Application Priority Data
Apr. 9, 2018 (TW) 107112073

(51) Int. Cl. H02K 3/28; H02K 1/14; H02K 3/18

(52) U.S. Cl. CPC H02K 3/28; H02K 3/18; H02K 1/146

(57) ABSTRACT

The present disclosure provides a three-phase motor stator. The three-phase motor stator includes a stator iron core, a first winding, a second winding, and a third winding. The stator iron core has a ring part and a plurality of pole arms. The total number of the pole arms is a multiple of six and is at least twelve. The pole arms are distinguished as at least two first phase pole arm groups, at least two second phase pole arm groups, and at least two third phase pole arm groups. The first phase pole arm group, the second phase pole arm group, and the third phase pole arm group are arranged at intervals. The first winding, the second winding and the third winding each has a plurality of coils, and the coils are respectively wound around the pole arms of the first phase pole arm group, the second phase pole arm group and the third phase pole arm group.

### BACKGROUND OF THE DISCLOSURE

### 1. Field of the Disclosure

The disclosure relates to a three-phase motor stator.

### 2. Description of the Related Art

A conventional motor includes a stator and a rotor. There is a gap between the stator and the rotor. The stator has a coil winding. The coil winding may be connected to electricity to generate a magnetic field, by which the rotor is driven to rotate.

However, in an electricity connection process, it easily occurs that electromagnetic torques of the coil winding of the stator are not balanced when electric potentials are not balanced, causing the rotor to shake in a rotating process and further generate an inappropriate abnormal sound. In addition, when currents of the coil winding of the stator in all phases are not balanced, there may be reverse currents or a reverse magnetic field between the stator and the rotor. Consequently, a relatively large reverse torque is further generated, and the overall operation efficiency of the motor is easily affected.

### SUMMARY OF THE DISCLOSURE

The present disclosure provides a three-phase motor stator. In an embodiment, the three-phase motor stator includes: a stator iron core, a first winding, a second winding, and a third winding. The stator iron core has a ring part and a plurality of pole arms. The total number of the pole arms is a multiple of six and is at least twelve. One end of the pole arm is disposed at the ring part. The pole arms are distinguished as at least two first phase pole arm groups, at least two second phase pole arm groups, and at least two third phase pole arm groups. The first phase pole arm group, the second phase pole arm group, and the third phase pole arm group each include at least two pole arms. The at least two pole arms of the first phase pole arm group are disposed near. The at least two pole arms of the second phase pole arm group are disposed near. The at least two pole arms of the third phase pole arm group are disposed near. The first phase pole arm group, the second phase pole arm group, and the third phase pole arm group are arranged at intervals in a circumference direction of the ring part. The first winding has a plurality of coils, and the coils are respectively wound around the pole arms of the first phase pole arm group. The second winding has a plurality of coils, and the coils are respectively wound around the pole arms of the second phase pole arm group. The third winding has a plurality of coils, and the coils are respectively wound around the pole arms of the third phase pole arm group.

Therefore, by using that the first phase pole arm group, the second phase pole arm group, and the third phase pole arm group of the stator iron core are arranged in a staggered manner, and are in combination with the coils of the first winding, the second winding, and the third winding which are wound in different directions in a staggered manner, after the first winding, the second winding, and the third winding are connected to electricity, the first winding, the second winding, and the third winding can provide a preferred relationship of electric potentials, thereby improving the operation efficiency of the motor.

### BRIEF DESCRIPTION OF THE DRAWINGS

FIG. 1 is a schematic diagram of a three-phase motor stator according to an embodiment of the present invention.

FIG. 2 is a schematic diagram of a three-phase motor stator according to another embodiment of the present invention.

FIG. 3 is a schematic diagram of a three-phase motor stator according to still another embodiment of the present invention.

FIG. 4 is a schematic diagram showing that all windings of a three-phase motor stator are in a Δ-type connection.

FIG. 5 is a schematic diagram showing that all windings of a three-phase motor stator are in a Y-type connection.

FIG. 6 is a schematic diagram of a three-phase motor stator of which a stator iron core is an outer rotor-type stator iron core.

FIG. 7 is a schematic diagram of a three-phase motor stator of which a stator iron core is an inner-rotor type stator iron core.

### DETAILED DESCRIPTION OF THE DISCLOSURE

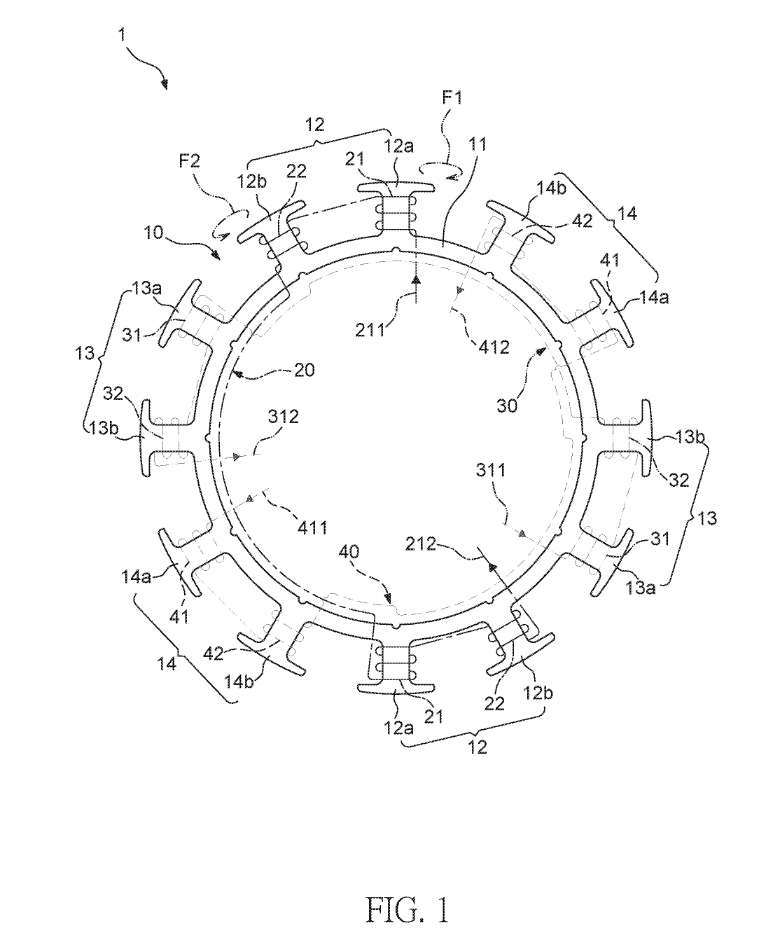

FIG. 1 is a schematic diagram of a three-phase motor stator according to an embodiment of the present invention. With reference to FIG. 1, in an embodiment, according to the present invention the three-phase motor stator 1 includes a stator iron core 10, a first winding 20, a second winding 30, and a third winding 40. According to the present invention the three-phase motor stator 1 may be connected to electricity to generate an alternating magnetic field for driving a rotor (not shown) to rotate, by which a motor structure capable of providing a rotary power is formed and is applicable to various devices in the industry, people's livelihood, or transportation.

The stator iron core 10 has a ring part 11 and a plurality of pole arms. The total number of the pole arms is a multiple of six and is at least twelve. For example, according to the present invention the stator iron core 10 of the three-phase motor stator 1 may optionally have 12 pole arms, 18 pole arms, 24 pole arms, . . . and so on. The stator iron core 10 may be formed by laminating a plurality of silicon steel sheets, but the present invention is not limited thereto. One end of the pole arm is disposed at the ring part 11. The pole arms are distinguished as at least two first phase pole arm groups 12, at least two second phase pole arm groups 13, and at least two third phase pole arm groups 14. The first phase pole arm group 12, the second phase pole arm group 13, and the third phase pole arm group 14 each include at least two pole arms. The at least two pole arms of the first phase pole arm group 12 are disposed near. The at least two pole arms of the second phase pole arm group 13 are disposed near. The at least two pole arms of the third phase pole arm group 14 are disposed near. The first phase pole arm group 12, the second phase pole arm group 13, and the third phase pole arm group 14 are arranged at intervals in a circumference direction of the ring part 11. Preferably, the intervals between the pole arm groups are equal.

The first winding 20 has a plurality of coils, and the coils are respectively wound around the pole arms of the first phase pole arm group 12. The second winding 30 has a plurality of coils, and the coils are respectively wound around the pole arms of the second phase pole arm group 13. The third winding 40 has a plurality of coils, and the coils are respectively wound around the pole arms of the third phase pole arm group 14.

According to the present invention the three-phase motor stator 1 uses a design in which the first phase pole arm group 12, the second phase pole arm group 13 and the third phase pole arm group 14 of the stator iron core 10 are arranged at intervals in the circumference direction of the ring part 11, and the first phase pole arm groups 12, the second phase pole arm groups 13 and the third phase pole arm groups 14 are arranged in a staggered manner. After the first winding 20, the second winding 30, and the third winding 40 are respectively wound around the first phase pole arm group 12, the second phase pole arm group 13 and the third phase pole arm group 14 and are connected to electricity, a preferred balanced relationship between electric potentials may be provided, to ensure generated electromagnetic torques to be balanced, avoid an excessive shake that occurs during rotation of the rotor (not shown) driven by the three-phase motor stator 1, and effectively avoid an inappropriate abnormal sound, thereby improving the operation quality of the motor.

Based on the foregoing structural design, the following further describes a plurality of embodiments in detail, to describe different types of stator iron cores 10 used by the three-phase motor stator 1 according to the present invention, and various winding manners for the first winding 20, the second winding 30, and the third winding 40, but the present invention is not limited to the embodiments listed below.

With reference to FIG. 1 again, in an embodiment, the total number of the pole arms is twelve. There are two first phase pole arm groups 12, and each first phase pole arm group 12 has a first phase pole arm-A 12a and a first phase pole arm-B 12b. The first phase pole arm-A 12a is adjacent to the first phase pole arm-B 12b. There are two second phase pole arm groups 13, and each second phase pole arm group 13 has a second phase pole arm-A 13a and a second phase pole arm-B 13b. The second phase pole arm-A 13a is adjacent to the second phase pole arm-B 13b. There are two third phase pole arm groups 14, and each third phase pole arm group 14 has a third phase pole arm-A 14a and a third phase pole arm-B 14b. The third phase pole arm-A 14a is adjacent to the third phase pole arm-B 14b.

In an embodiment, the first phase pole arm group 12 may be located between the second phase pole arm group 13 and the third phase pole arm group 14. The second phase pole arm group 13 may be located between the first phase pole arm group 12 and the third phase pole arm group 14. The third phase pole arm group 14 may be located between the first phase pole arm group 12 and the second phase pole arm group 13. The first phase pole arm-B 12b of the first phase pole arm group 12 may be adjacent to the second phase pole arm-A 13a of the second phase pole arm group 13. The second phase pole arm-B 13b of the second phase pole arm group 13 may be adjacent to the third phase pole arm-A 14a of the third phase pole arm group 14. The third phase pole arm-B 14b of the third phase pole arm group 14 may be adjacent to the first phase pole arm-A 12a of the first phase pole arm group 12. However, the present invention is not limited thereto.

Based on that the first winding 20 is wound around the first phase pole arm group 12, the first winding 20 may include two first phase coil-As 21 and two first phase coil-Bs 22. The first phase coil-A 21 of the first winding 20 is wound around the first phase pole arm-A 12a of the first phase pole arm group 12 in a first direction F1. The first phase coil-B 22 of the first winding 20 is wound around the first phase pole arm-B 12b of the first phase pole arm group 12 in a second direction F2. Based on that the second winding 30 is wound around the second phase pole arm group 13, the second winding 30 may include two second phase coil-As 31 and two second phase coil-Bs 32. The second phase coil-A 31 of the second winding 30 is wound around the second phase pole arm-A 13a of the second phase pole arm group 13 in the first direction F1. The second phase coil-B 32 of the second winding 30 is wound around the second phase pole arm-B 13b of the second phase pole arm group 13 in the second direction F2. Based on that the third winding 40 is wound around the third phase pole arm group 14, the third winding 40 may include two third phase coil-As 41 and two third phase coil-Bs 42. The third phase coil-A 41 of the third winding 40 is wound around the third phase pole arm-A 14a of the third phase pole arm group 14 in the first direction F1. The third phase coil-B 42 of the third winding 40 is wound around the third phase pole arm-B 14b of the third phase pole arm group 14 in the second direction F2.

In an embodiment, in a view from a direction from the outer diameter to the inner diameter of the ring part 11, the first direction F1 of the first winding 20, the second winding 30, and the third winding 40 may be a clockwise direction, and the second direction F2 may be a counterclockwise direction; or the first direction F1 may be a counterclockwise direction, and the second direction F2 may be a clockwise direction. Hereby, the first phase coil-A 21 and the first phase coil-B 22 of the first winding 20, the second phase coil-A 31 and the second phase coil-B 32 of the second winding 30, the third phase coil-A 41 and the third phase coil-B 42 of the third winding 40 are wound in a staggered manner in different directions. In details, the first phase coil-A 21 of the first winding 20 is wound in the first direction F1, the first phase coil-B 22 of the first winding 20 is wound in the second direction F2, the second phase coil-A 31 of the second winding 30 is wound in the first direction F1, the second phase coil-B 32 of the second winding 30 is wound in the second direction F2, and so on.

The embodiment of FIG. 1 is based on a configuration structure of two first phase pole arm groups 12, two second phase pole arm groups 13, and two third phase pole arm groups 14 (twelve pole arms in total). The first phase pole arm group 12, the second phase pole arm group 13, and the third phase pole arm group 14 may be near and arranged in a staggered manner, and are in combination with the first phase coil-A 21 and the first phase coil-B 22 of the first winding 20, the second phase coil-A 31 and the second phase coil-B 32 of the second winding 30, the third phase coil-A 41 and the third phase coil-B 42 of the third winding 40, which are wound in different directions in a staggered manner. Therefore, currents generated by the first winding 20, the second winding 30, and the third winding 40 in all phases are easy to be balanced after the first winding 20, the second winding 30, and the third winding 40 are connected to electricity, so that reverse torques that may be generated between the three-phase motor stator 1 according to the present invention and the rotor (not shown) can be reduced, thereby improving the overall operation efficiency of the motor.

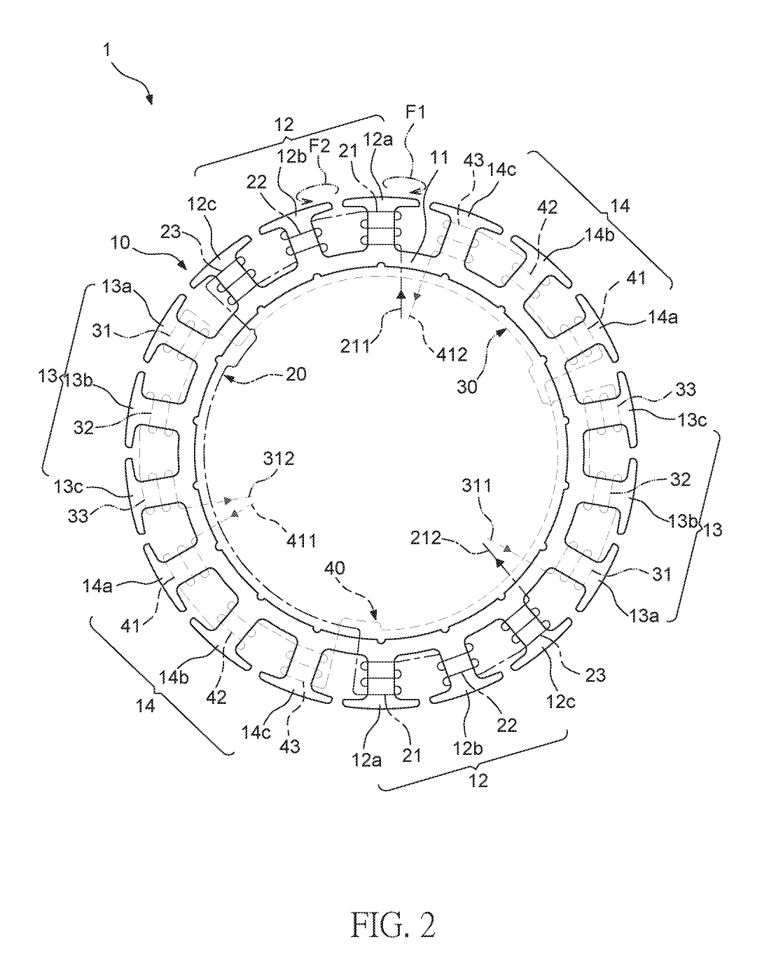

FIG. 2 is a schematic diagram of a three-phase motor stator according to another embodiment of the present invention. With reference to FIG. 2, in an embodiment, the total number of pole arms is eighteen. There are two first phase pole arm groups 12, and each first phase pole arm group 12 has a first phase pole arm-A 12a, a first phase pole arm-B 12b, and a first phase pole arm-C 12c. The first phase pole arm-A 12a is adjacent to the first phase pole arm-B 12b, and the first phase pole arm-B 12b is adjacent to the first phase pole arm-C 12c. There are two second phase pole arm groups 13, and each second phase pole arm group 13 has a second phase pole arm-A 13a, a second phase pole arm-B 13b, and a second phase pole arm-C 13c. The second phase pole arm-A 13a is adjacent to the second phase pole arm-B 13b, the second phase pole arm-B 13b is adjacent to the second phase pole arm-C 13c. There are two third phase pole arm groups 14, and each third phase pole arm group 14 has a third phase pole arm-A 14a, a third phase pole arm-B 14b, and a third phase pole arm-C 14c. The third phase pole arm-A 14a is adjacent to the third phase pole arm-B 14b, and the third phase pole arm-B 14b is adjacent to the third phase pole arm-C 14c.

The first phase pole arm group 12 may be located between the second phase pole arm group 13 and the third phase pole arm group 14. The second phase pole arm group 13 may be located between the first phase pole arm group 12 and the third phase pole arm group 14. The third phase pole arm group 14 may be located between the first phase pole arm group 12 and the second phase pole arm group 13. The first phase pole arm-C 12c of the first phase pole arm group 12 may be adjacent to the second phase pole arm-A 13a of the second phase pole arm group 13. The second phase pole arm-C 13c of the second phase pole arm group 13 may be adjacent to the third phase pole arm-A 14a of the third phase pole arm group 14. The third phase pole arm-C 14c of the third phase pole arm group 14 may be adjacent to the first phase pole arm-A 12a of the first phase pole arm group 12. However, the present invention is not limited thereto.

Based on that the first winding 20 is wound around the first phase pole arm group 12, the first winding 20 may include two first phase coil-As 21, two first phase coil-Bs 22, and two first phase coil-Cs 23. The first phase coil-A 21 of the first winding 20 is wound around the first phase pole arm-A 12a of the first phase pole arm group 12 in the first direction F1. The first phase coil-B 22 of the first winding 20 is wound around the first phase pole arm-B 12b of the first phase pole arm group 12 in the second direction F2. The first phase coil-C 23 of the first winding 20 is wound around the first phase pole arm-C 12c of the first phase pole arm group 12 in the first direction F1. Based on that the second winding 30 is wound around the second phase pole arm group 13, the second winding 30 may include two second phase coil-As 31, two second phase coil-Bs 32, and two second phase coil-Cs 33. The second phase coil-A 31 of the second winding 30 is wound around the second phase pole arm-A 13a of the second phase pole arm group 13 in the first direction F1. The second phase coil-B 32 of the second winding 30 is wound around the second phase pole arm-B 13b of the second phase pole arm group 13 in the second direction F2. The second phase coil-C 33 of the second winding 30 is wound around the second phase pole arm-C 13c of the second phase pole arm group 13 in the first direction F1. Based on that the third winding 40 is wound around the third phase pole arm group 14, the third winding 40 may include two third phase coil-As 41, two third phase coil-Bs 42, and two third phase coil-Cs 43. The third phase coil-A 41 of the third winding 40 is wound around the third phase pole arm-A 14a of the third phase pole arm group 14 in the first direction F1. The third phase coil-B 42 of the third winding 40 is wound around the third phase pole arm-B 14b of the third phase pole arm group 14 in the second direction F2. The third phase coil-C 43 of the third winding 40 is wound around the third phase pole arm-C 14c of the third phase pole arm group 14 in the first direction F1.

In an embodiment, in a view from a direction from the outer diameter to the inner diameter of the ring part 11, the first direction F1 of the first winding 20, the second winding 30, and the third winding 40 may be a clockwise direction, and the second direction F2 may be a counterclockwise direction; or the first direction F1 may be a counterclockwise direction, and the second direction F2 may be a clockwise direction. Hereby, the first phase coil-A 21, the first phase coil-B 22, the first phase coil-C 23 of the first winding 20, the second phase coil-A 31, the second phase coil-B 32, and the second phase coil-C 33 of the second winding 30, the third phase coil-A 41, the third phase coil-B 42, and the third phase coil-C 43 of the third winding 40 are wound in a staggered manner in different directions. In details, the first phase coil-A 21 of the first winding 20 is wound in the first direction F1, the first phase coil-B 22 of the first winding 20 is wound in the second direction F2, the first phase coil-C 23 of the first winding 20 is wound in the first direction F1. The second phase coil-A 31 of the second winding 30 is wound in the first direction F1, the second phase coil-B 32 of the second winding 30 is wound in the second direction F2, the second phase coil-C 33 of the second winding 30 is wound in the first direction F1, and so on.

The embodiment of FIG. 2 is based on a configuration structure of two first phase pole arm groups 12, two second phase pole arm groups 13, and two third phase pole arm groups 14 (eighteen pole arms in total). The first phase pole arm group 12, the second phase pole arm group 13, and the third phase pole arm group 14 may be arranged in a staggered manner, and are in combination with the first phase coil-A 21, the first phase coil-B 22, and the first phase coil-C 23 of the first winding 20, the second phase coil-A 31, the second phase coil-B 32, and the second phase coil-C 33 of the second winding 30, the third phase coil-A 41, the third phase coil-B 42, and the third phase coil-C 43 of the third winding 40, which are wound in different directions in a staggered manner. Therefore, currents generated by the first winding 20, the second winding 30, and the third winding 40 in all phases are easy to be balanced after the first winding 20, the second winding 30 and the third winding 40 are connected to electricity, so that reverse torques that may be generated between the three-phase motor stator 1 according to the present invention and the rotor (not shown) can be reduced, thereby improving the overall operation efficiency of the motor.

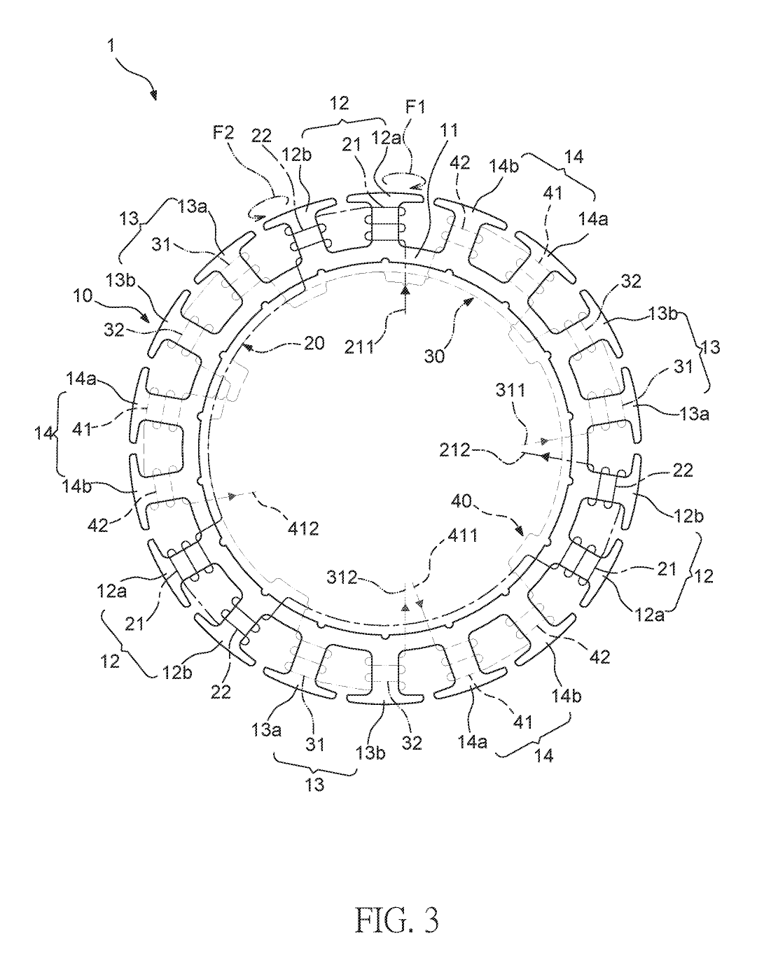

FIG. 3 is a schematic diagram of a three-phase motor stator according to still another embodiment of the present invention. With reference to FIG. 3, in this embodiment, the total number of pole arms is eighteen. There are three first phase pole arm groups 12, and each first phase pole arm group 12 has a first phase pole arm-A 12a and a first phase pole arm-B 12b. The first phase pole arm-A 12a is adjacent to the first phase pole arm-B 12b. There are three second phase pole arm groups 13, and each second phase pole arm group 13 has a second phase pole arm-A 13a and a second phase pole arm-B 13b. The second phase pole arm-A 13a is adjacent to the second phase pole arm-B 13b. There are three third phase pole arm groups 14, and each third phase pole arm group 14 has a third phase pole arm-A 14a and a third phase pole arm-B 14b. The third phase pole arm-A 14a is adjacent to the third phase pole arm-B 14b.

The first phase pole arm group 12 may be located between the second phase pole arm group 13 and the third phase pole arm group 14. The second phase pole arm group 13 may be located between the first phase pole arm group 12 and the third phase pole arm group 14. The third phase pole arm group 14 may be located between the first phase pole arm group 12 and the second phase pole arm group 13. The first phase pole arm-B 12b of the first phase pole arm group 12 may be adjacent to the second phase pole arm-A 13a of the second phase pole arm group 13. The second phase pole arm-B 13b of the second phase pole arm group 13 may be adjacent to the third phase pole arm-A 14a of the third phase pole arm group 14. The third phase pole arm-B 14b of the third phase pole arm group 14 may be adjacent to the first phase pole arm-A 12a of the first phase pole arm group 12. However, the present invention is not limited thereto.

Based on that the first winding 20 is wound around the first phase pole arm group 12, the first winding 20 may include three first phase coil-As 21 and three first phase coil-Bs 22. The first phase coil-A 21 of the first winding 20 is wound around the first phase pole arm-A 12a of the first phase pole arm group 12 in the first direction F1. The first phase coil-B 22 of the first winding 20 is wound around the first phase pole arm-B 12b of the first phase pole arm group 12 in the second direction F2. Based on that the second winding 30 is wound around the second phase pole arm group 13, the second winding 30 may include three second phase coil-As 31 and three second phase coil-Bs 32. The second phase coil-A 31 of the second winding 30 is wound around the second phase pole arm-A 13a of the second phase pole arm group 13 in the first direction F1. The second phase coil-B 32 of the second winding 30 is wound around the second phase pole arm-B 13b of the second phase pole arm group 13 in the second direction F2. Based on that the third winding 40 is wound around the third phase pole arm group 14, the third winding 40 may include three third phase coil-As 41 and three third phase coil-Bs 42. The third phase coil-A 41 of the third winding 40 is wound around the third phase pole arm-A 14a of the third phase pole arm group 14 in the first direction F1. The third phase coil-B 42 of the third winding 40 is wound around the third phase pole arm-B 14b of the third phase pole arm group 14 in the second direction F2.

In an embodiment, in a view from a direction from the outer diameter to the inner diameter of the ring part 11, the first direction F1 of the first winding 20, the second winding 30 and the third winding 40 may be a clockwise direction, and the second direction F2 may be a counterclockwise direction; or the first direction F1 may be a counterclockwise direction, and the second direction F2 may be a clockwise direction. Hereby, the first phase coil-A 21 and the first phase coil-B 22 of the first winding 20, the second phase coil-A 31 and the second phase coil-B 32 of the second winding 30, the third phase coil-A 41 and the third phase coil-B 42 of the third winding 40 are also wound in a staggered manner in different directions. In details, the first phase coil-A 21 of the first winding 20 is wound in the first direction F1, the first phase coil-B 22 of the first winding 20 is wound in the second direction F2, the second phase coil-A 31 of the second winding 30 is wound in the first direction F1, the second phase coil-B 32 of the second winding 30 is wound in the second direction F2, and so on.

The embodiment of FIG. 3 is based on a configuration structure of three first phase pole arm groups 12, three second phase pole arm groups 13, and three third phase pole arm groups 14 (eighteen pole arms in total). The first phase pole arm group 12, the second phase pole arm group 13, and the third phase pole arm group 14 may be arranged in a staggered manner, and are in combination with the first phase coil-A 21 and the first phase coil-B 22 of the first winding 20, the second phase coil-A 31 and the second phase coil-B 32 of the second winding 30, the third phase coil-A 41 and the third phase coil-B 42 of the third winding 40, which are wound in different directions in a staggered manner. Therefore, currents generated by the first winding 20, the second winding 30, and the third winding 40 in all phases are easy to be balanced after the first winding 20, the second winding 30 and the third winding 40 are connected to electricity, so that reverse torques that may be generated between the three-phase motor stator 1 according to the present invention and the rotor (not shown) can be reduced, thereby improving the overall operation efficiency of the motor.

The coils of the first winding 20, the second winding 30, and the third winding 40 may be respectively wound around the pole arms of the stator iron core 10 in a unified winding manner, but the present invention is not limited thereto. In details, with reference to FIG. 1 to FIG. 3, the unified winding manner is that one coil is wound around each pole arm of the stator iron core 10 in a unified manner. Hereby, the winding complexity of the first winding 20, the second winding 30, and the third winding 40 can be simplified, thereby improving the winding convenience.

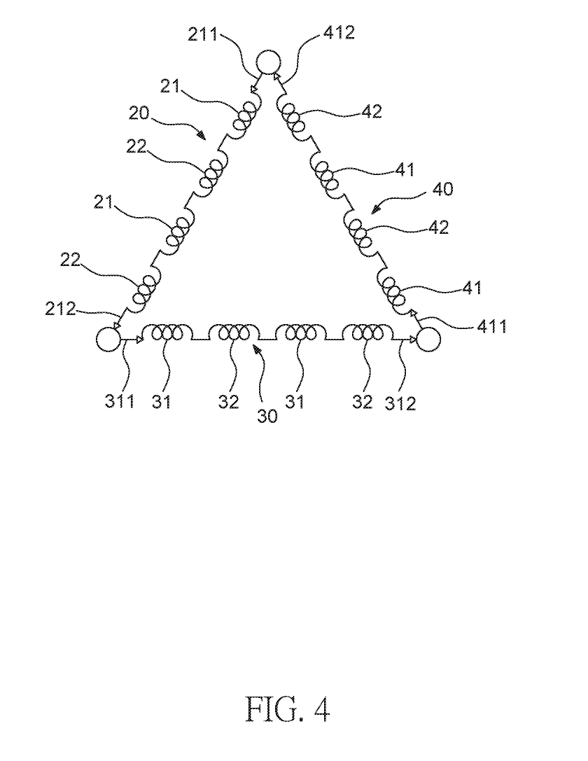

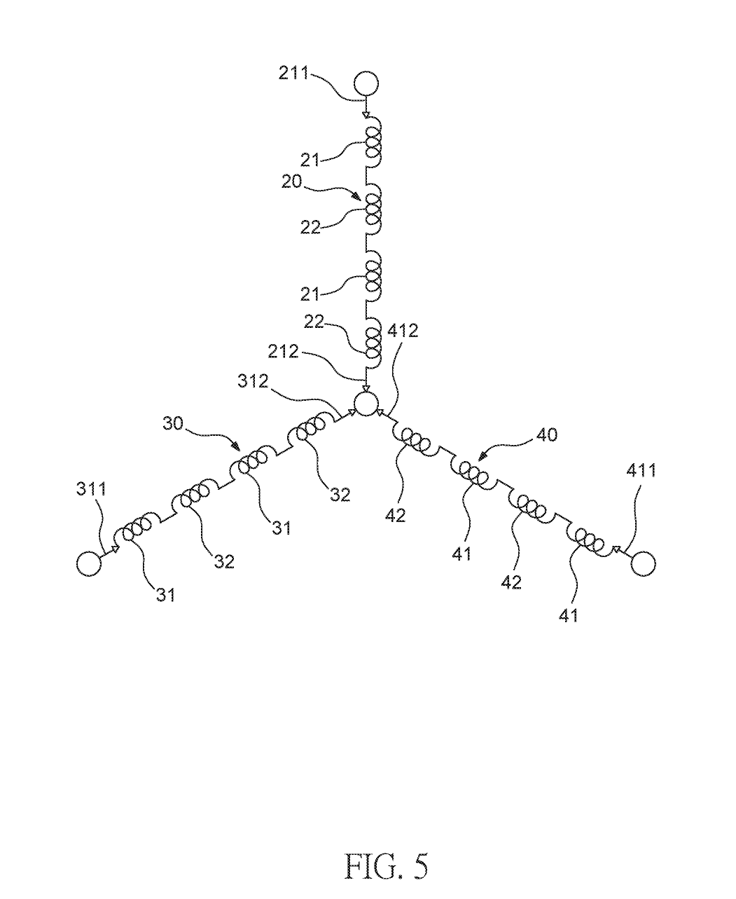

FIG. 4 is a schematic diagram showing that all windings of a three-phase motor stator are in a Δ-type connection. With reference to FIG. 1 and FIG. 4, in an embodiment, the first winding 20 has a first line feeding end 211 and a first out-going line end 212. The second winding 30 has a second line feeding end 311 and a second out-going line end 312. The third winding 40 has a third line feeding end 411 and a third out-going line end 412. The first out-going line end 212 of the first winding 20 is coupled to the second line feeding end 311 of the second winding 30. The second out-going line end 312 of the second winding 30 is coupled to the third line feeding end 411 of the third winding 40. The third out-going line end 412 of the third winding 40 is coupled to the first line feeding end 211 of the first winding 20. In addition, FIG. 5 is a schematic diagram showing that all windings of a three-phase motor stator are in a Y-type connection. With reference to FIG. 1 and FIG. 5, in an embodiment, the first out-going line end 212 of the first winding 20, the second out-going line end 312 of the second winding 30, and the third out-going line end 412 of the third winding 40 are coupled to each other.

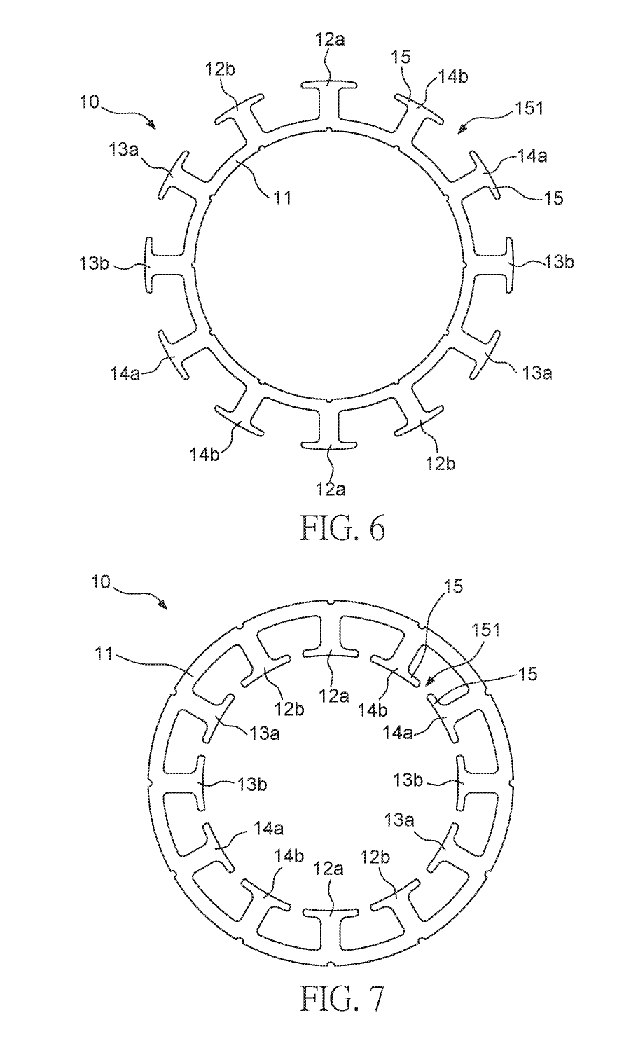

FIG. 6 is a schematic diagram of a three-phase motor stator of which a stator iron core is an outer rotor-type stator iron core. With reference to FIG. 6, in an embodiment, one end of the pole arm of the stator iron core 10 is disposed at an outer periphery of the ring part 11, and the other end of the pole arm is provided with a boot part 15. A groove opening 151 is formed between the boot parts 15. Alternatively, FIG. 7 is a schematic diagram of a three-phase motor stator of which a stator iron core is an inner-rotor type stator iron core. With reference to FIG. 7, in an embodiment, one end of the pole arm of the stator iron core 10 is disposed at an inner periphery of the ring part 11, and the other end of the pole arm is provided with a boot part 15. A groove opening 151 is formed between the boot parts 15. Based on the above, the embodiments disclosed in FIG. 1 to FIG. 5 are all applicable to the outer rotor-type stator iron core or the inner rotor-type stator iron core.

In the foregoing embodiments, the first phase pole arm group 12, the second phase pole arm group 13, and the third phase pole arm group 14 of the stator iron core 10 are arranged in a staggered manner, and are in combination with the coils of the first winding 20, the second winding 30, and the third winding 40 which are wound in different directions in a staggered manner. Therefore, after the first winding 20, the second winding 30, and the third winding 40 are connected to electricity, the first winding 20, the second winding 30, and the third winding 40 can provide a preferred relationship of electric potentials for the first phase pole arm group 12, the second phase pole arm group 13, and the third phase pole arm group 14, thereby improving the operation efficiency of the motor.

While several embodiments of the present disclosure have been illustrated and described, various modifications and improvements can be made by those skilled in the art. The embodiments of the present disclosure are therefore described in an illustrative but not in a restrictive sense. It is intended that the present disclosure should not be limited to the particular forms as illustrated and that all modifications which maintain the spirit and scope of the present disclosure are within the scope defined in the appended claims.

What is claimed is:

1. A three-phase motor stator comprising:
a stator iron core, having a ring part and a plurality of pole arms, wherein the total number of the pole arms is a multiple of six and is at least twelve, and one end of the pole arm is disposed at the ring part, the pole arms are distinguished as at least two first phase pole arm groups, at least two second phase pole arm groups, and at least two third phase pole arm groups; the first phase pole arm group, the second phase pole arm group, and the third phase pole arm group each comprise at least two pole arms, the at least two pole arms of the first phase pole arm group are disposed near, the at least two pole arms of the second phase pole arm group are disposed near, the at least two pole arms of the third phase pole arm group are disposed near; the first phase pole arm group, the second phase pole arm group, and the third phase pole arm group are arranged at intervals in a circumference direction of the ring part;
a first winding, having a plurality of coils, the coils respectively wound around the pole arms of the first phase pole arm group;
a second winding, having a plurality of coils, the coils respectively wound around the pole arms of the second phase pole arm group; and
a third winding, having a plurality of coils, the coils respectively wound around the pole arms of the third phase pole arm group.

2. The three-phase motor stator according to claim 1, wherein the total number of the pole arms is twelve, there are two first phase pole arm groups, and each first phase pole arm group has a first phase pole arm-A and a first phase pole arm-B; there are two second phase pole arm groups, and each second phase pole arm group has a second phase pole arm-A and a second phase pole arm-B; there are two third phase pole arm groups, and each third phase pole arm group has a third phase pole arm-A and a third phase pole arm-B.

3. The three-phase motor stator according to claim 2, wherein the first winding comprises two first phase coil-As and two first phase coil-Bs, the first phase coil-A of the first winding is wound around the first phase pole arm-A of the first phase pole arm group in a first direction, the first phase coil-B of the first winding is wound around the first phase pole arm-B of the first phase pole arm group in a second direction; the second winding comprises two second phase coil-As and two second phase coil-Bs, the second phase coil-A of the second winding is wound around the second phase pole arm-A of the second phase pole arm group in the first direction, the second phase coil-B of the second winding is wound around the second phase pole arm-B of the second phase pole arm group in the second direction; the third winding comprises two third phase coil-As and two third phase coil-Bs, the third phase coil-A of the third winding is wound around the third phase pole arm-A of the third phase pole arm group in the first direction, the third phase coil-B of the third winding is wound around the third phase pole arm-B of the third phase pole arm group in the second direction.

4. The three-phase motor stator according to claim 3, wherein in a view from a direction from the outer diameter to the inner diameter of the ring part, the first direction is a clockwise direction, and the second direction is a counterclockwise direction.

5. The three-phase motor stator according to claim 3, wherein in a view from a direction from the outer diameter to the inner diameter of the ring part, the first direction is a counterclockwise direction, and the second direction is a clockwise direction.

6. The three-phase motor stator according to claim 2, wherein the first phase pole arm group is located between the second phase pole arm group and the third phase pole arm group, the second phase pole arm group is located between the first phase pole arm group and the third phase pole arm group, the third phase pole arm group is located between the first phase pole arm group and the second phase pole arm group.

7. The three-phase motor stator according to claim 6, wherein the first phase pole arm-B of the first phase pole arm group is adjacent to the second phase pole arm-A of the second phase pole arm group, the second phase pole arm-B of the second phase pole arm group is adjacent to the third phase pole arm-A of the third phase pole arm group, the third phase pole arm-B of the third phase pole arm group is adjacent to the first phase pole arm-A of the first phase pole arm group.

8. The three-phase motor stator according to claim 1, wherein the total number of pole arms is eighteen, there are two first phase pole arm groups, and each first phase pole arm group has a first phase pole arm-A, a first phase pole arm-B, and a first phase pole arm-C; there are two second phase pole arm groups, and each second phase pole arm group has a second phase pole arm-A, a second phase pole arm-B, and a second phase pole arm-C; there are two third phase pole arm groups, and each third phase pole arm group has a third phase pole arm-A, a third phase pole arm-B, and a third phase pole arm-C.

9. The three-phase motor stator according to claim 8, wherein the first winding comprises two first phase coil-As, two first phase coil-Bs, and two first phase coil-Cs, the first phase coil-A of the first winding is wound around the first phase pole arm-A of the first phase pole arm group in a first direction, the first phase coil-B of the first winding is wound around the first phase pole arm-B of the first phase pole arm group in a second direction, the first phase coil-C of the first winding is wound around the first phase pole arm-C of the first phase pole arm group in the first direction; the second winding comprises two second phase coil-As, two second phase coil-Bs, and two second phase coil-Cs, the second phase coil-A of the second winding is wound around the second phase pole arm-A of the second phase pole arm group in the first direction, the second phase coil-B of the second winding is wound around the second phase pole arm-B of the second phase pole arm group in the second direction, the second phase coil-C of the second winding is wound around the second phase pole arm-C of the second phase pole arm group in the first direction; the third winding comprises two third phase coil-As, two third phase coil-Bs, and two third phase coil-Cs. the third phase coil-A of the third winding is wound around the third phase pole arm-A of the third phase pole arm group in the first direction, the third phase coil-B of the third winding is wound around the third phase pole arm-B of the third phase pole arm group in the second direction, the third phase coil-C of the third winding is wound around the third phase pole arm-C of the third phase pole arm group in the first direction.

10. The three-phase motor stator according to claim 9, wherein in a view from a direction from the outer diameter to the inner diameter of the ring part, the first direction is a clockwise direction, and the second direction is a counterclockwise direction.

11. The three-phase motor stator according to claim 9, wherein in a view from a direction from the outer diameter to the inner diameter of the ring part, the first direction is a counterclockwise direction, and the second direction is a clockwise direction.

12. The three-phase motor stator according to claim 8, wherein the first phase pole arm group is located between the second phase pole arm group and the third phase pole arm group, the second phase pole arm group is located between the first phase pole arm group and the third phase pole arm group, the third phase pole arm group is located between the first phase pole arm group and the second phase pole arm group.

13. The three-phase motor stator according to claim 12, wherein the first phase pole arm-C of the first phase pole arm group is adjacent to the second phase pole arm-A of the second phase pole arm group, the second phase pole arm-C of the second phase pole arm group is adjacent to the third phase pole arm-A of the third phase pole arm group, the third phase pole arm-C of the third phase pole arm group is adjacent to the first phase pole arm-A of the first phase pole arm group.

14. The three-phase motor stator according to claim 1, wherein the total number of pole arms is eighteen, there are three first phase pole arm groups, and each first phase pole arm group has a first phase pole arm-A and a first phase pole arm-B; there are three second phase pole arm groups, and each second phase pole arm group has a second phase pole arm-A and a second phase pole arm-B; there are three third phase pole arm groups, and each third phase pole arm group has a third phase pole arm-A and a third phase pole arm-B.

15. The three-phase motor stator according to claim 14, wherein the first winding comprises three first phase coil-As and three first phase coil-Bs, the first phase coil-A of the first winding is wound around the first phase pole arm-A of the first phase pole arm group in a first direction, the first phase coil-B of the first winding is wound around the first phase pole arm-B of the first phase pole arm group in a second direction; the second winding comprises three second phase coil-As and three second phase coil-Bs, the second phase coil-A of the second winding is wound around the second phase pole arm-A of the second phase pole arm group in the first direction, the second phase coil-B of the second winding is wound around the second phase pole arm-B of the second phase pole arm group in the second direction; the third winding comprises three third phase coil-As and three third phase coil-Bs, the third phase coil-A of the third winding is wound around the third phase pole arm-A of the third phase pole arm group in the first direction, the third phase coil-B of the third winding is wound around the third phase pole arm-B of the third phase pole arm group in the second direction.

16. The three-phase motor stator according to claim 15, wherein in a view from a direction from the outer diameter to the inner diameter of the ring part, the first direction is a clockwise direction, and the second direction is a counterclockwise direction.

17. The three-phase motor stator according to claim 15, wherein in a view from a direction from the outer diameter to the inner diameter of the ring part, the first direction is a counterclockwise direction, and the second direction is a clockwise direction.

18. The three-phase motor stator according to claim 14, wherein the first phase pole arm group is located between the second phase pole arm group and the third phase pole arm group, the second phase pole arm group is located between the first phase pole arm group and the third phase pole arm group, the third phase pole arm group is located between the first phase pole arm group and the second phase pole arm group.

19. The three-phase motor stator according to claim 18, wherein the first phase pole arm-B of the first phase pole arm group is adjacent to the second phase pole arm-A of the second phase pole arm group, the second phase pole arm-B of the second phase pole arm group is adjacent to the third phase pole arm-A of the third phase pole arm group, the third phase pole arm-B of the third phase pole arm group is adjacent to the first phase pole arm-A of the first phase pole arm group.

20. The three-phase motor stator according to claim 1, wherein the first winding has a first line feeding end and a first out-going line end, the second winding has a second line feeding end and a second out-going line end, the third winding has a third line feeding end and a third out-going line end; the first out-going line end of the first winding is coupled to the second line feeding end of the second winding, the second out-going line end of the second winding is coupled to the third line feeding end of the third winding, the third out-going line end of the third winding is coupled to the first line feeding end of the first winding.

21. The three-phase motor stator according to claim 1, wherein the first winding has a first line feeding end and a first out-going line end, the second winding has a second line feeding end and a second out-going line end, the third winding has a third line feeding end and a third out-going line end; the first out-going line end of the first winding, the second out-going line end of the second winding, and the third out-going line end of the third winding are coupled to each other.

22. The three-phase motor stator according to claim 1, wherein one end of the pole arm of the stator iron core is disposed at an outer periphery of the ring part, and the other end of the pole arm is provided with a boot part, and a groove opening is formed between the boot parts.

23. The three-phase motor stator according to claim 1, wherein one end of the pole arm of the stator iron core is disposed at an inner periphery of the ring part, and the other end of the pole arm is provided with a boot part, and a groove opening is formed between the boot parts.

24. The three-phase motor stator according to claim 1, wherein the stator iron core is formed by laminating a plurality of silicon steel sheets.
